(19) United States
(12) Patent Application Publication
(10) Pub. No.: US 2007/0263377 A1
(43) Pub. Date: Nov. 15, 2007

(54) Luminescent lamp shade

(76) Inventor: Gary L. Butler, College Park, GA (US)

Correspondence Address: MERCHANT & GOULD PC, P.O. BOX 2903, MINNEAPOLIS, MN, 55402-0903, US

(21) Appl. No.: 11/431,874

(22) Filed: May 10, 2006

(51) Int. Cl. F21V 9/16

(52) U.S. Cl. 362/84; 362/360

(57) ABSTRACT

The invention provides luminescent phosphor and a method for their manufacture. The invention further provides a method for increasing the resistance to heat and water for the luminescent phosphor by coating the luminescent phosphor. The invention further provides a lamp shade and signage that glows in the dark after activation by incident electromagnetic radiation. Furthermore, a reflector is incorporated into the lamp shade and/or signage to effectively direct the electromagnet radiation emitted from the luminescent phosphor into an open space.

### FIELD OF INVENTION

The present invention relates to a lamp shade. More particularly, to a luminescent lamp shade and/or signage having a phosphorescence compound impregnated in a substrate wherein after excitation by a light source, the luminescent lamp shade will “glow in the dark” for an extended period of time and is resistant to heat and water.

### BACKGROUND OF THE INVENTION

Luminescence is an adjective that describes a process in which a chemical compound or element absorbs energy from electromagnetic radiation, upon absorbing energy; electrons are excited to a higher energy state. When the electrons return to their ground state, electromagnetic radiation is emitted. A photoluminescent process is a subset of luminescence processes, and an adjective which describes a luminescence process that occurs when the incident radiation and emitted radiation are in the visible spectrum.

Phosphorescence is the persistent emission of electromagnetic radiation following exposure to and removal from exposure to incident electromagnetic radiation. An object that exhibits phosphorescence is also said to “glow in the dark.” A phosphor is a substance that exhibits phosphorescence or luminescence.

Fluorescence is luminescence that is caused by the absorption of incident electromagnetic radiation followed by nearly immediate reradiation of electromagnetic radiation. The reradiation ceases almost immediately when the incident radiation ceases. Furthermore, in a fluorescence process, the incident electromagnetic radiation usually has a wavelength that differs from that of the emitted electromagnetic radiation.

Luminescent lamp shades are generally manufactured by applying a glow in the dark ink to a cloth layer that is then bonded to a transparent plastic layer of the lamp shade. Shortcomings of this technique are that the glow in the dark ink must itself be translucent which restricts the selection of inks and the cloth layer must be either translucent or opaque which restricts the selection of cloths and inhibits light propagation. Another shortcoming is that the glow in the dark inks have a glow time of about 30 minutes to one hour.

Traditional Zinc-Sulfide luminescent phosphors are not chemically stable. In addition, Zinc-Sulfide luminescent phosphors have low brilliance, and in some instances contain radioactive elements. Aluminate and Silicate luminescent phosphors have better chemical stability and are the current standard for low illumination needs. Furthermore, Zinc-Sulfide, Aluminate and Silicate luminescent phosphors are not heat resistant or water tolerant. For example, at high temperatures (around 600° C. and above) the luminescent phosphors begin to oxidize and are not luminous.

There exists a need for a luminescent phosphor which has a high brilliance, and a glow time greater than one hour. In addition, there exists a need for a luminescent phosphor that is heat resistant and water tolerant. Furthermore, there exists a need for a phosphorescence lamp shade that will provide long phosphorescence times, as well as eliminate the application of inks to a cloth layer which must then be bonded to a transparent plastic layer.

### BRIEF SUMMARY OF THE INVENTION

An object of the present invention is to provide a high brilliance luminescent phosphor with phosphorescence times of up to and in excess of 8 hours which is both heat resistant and water tolerant. A further object of the invention is to provide a lamp shade and signage which incorporates phosphors with phosphorescence times up to and in excess of 8 hours. An even further object of the present invention is to eliminate the need to apply glow in the dark inks to cloth layers of lamp shades. In addition to lamp shades, phosphor can be incorporated into various polymers used in the construction of any light fixture, thereby providing light for use during power losses and/or other emergency situations.

Embodiments may be implemented as an article of manufacture such as a lamp shade. In addition, the phosphor can be incorporated into any polymer that can be incorporated into a self-supporting light fixture. The lamp shade and/or light fixture can be made from fire retardant, translucent resins blended with photoluminescent phosphor blends.

### BRIEF DESCRIPTION OF THE FIGURES

Non-limiting and non-exhaustive embodiments are described with reference to the following figures, wherein like reference numerals refer to like parts throughout the various views unless otherwise specified.

FIG. 1A-FIG. 1B depict a self supporting lamp shade consistent with an exemplary embodiment of the present invention.

FIG. 2A-2C depicts a method of constructing a lamp shade consistent with various embodiments of the present invention.

FIG. 3 depicts an alternate embodiment of the present invention in the form of an exit sign.

### DETAILED DESCRIPTION

Various embodiments are described more fully below with reference to the accompanying drawings, which form a part hereof, and which show specific exemplary embodiments for practicing the invention. However, embodiments may be implemented in many different forms and should not be construed as limited to the embodiments set forth herein; rather, these embodiments are provided so that this disclosure will be thorough and complete, and will fully convey the scope of the invention to those skilled in the art. Embodiments may be practiced as compounds, systems or devices. Accordingly, embodiments may take the form of a compound, a hardware implementation, accessories that can be added to existing hardware, or an implementation combining compounds, accessories and hardware aspects. The following detailed description is, therefore, not to be taken in a limiting sense.

The implementation is a matter of choice dependent on the performance requirements of the compound, lamp shade or other lighting fixtures. Accordingly, the logical operations making up the embodiments described herein are referred to alternatively as a compound, article of manufacture, a lamp shade, a lighting fixture, or lighted signage.

A phosphor may have an emission spectrum such that its phosphorescence falls largely within a particular color range. In particular, the phosphorescence may fall in the visible wavelength region. For example, if the phosphor emits primarily in the blue range, the phosphor may be called a blue phosphor. Approximate color ranges in the visual spectrum are as follows: violet or deep blue (about 390-about 455 nm), blue (about 455-about 492 nm), green (about 492-about 577 nm), yellow (about 577-about 597 nm), orange (about 597-about 622 nm), red (about 622-about 770 nm).

An acceptor ion is selected from rare earth ions, transition metal ions, or heavy metal ions which give luminescence in the UV, visible, and IR regions when incorporated into the host material. Acceptor ions useful in the present invention include, but are not limited to, Pr³⁺, Nd³⁺, Eu³⁺, Tb³⁺, Er³⁺, Tm³⁺, Ti²⁺, Cr³⁺, Mn²⁺, Ni²⁺, and Bi³⁺.

A donor emitter ion is selected from divalent and trivalent rare earth (lanthanide) and actinide ions and ions of IVA and VA elements in low oxidation states. Useful actinide ions include uranium ions. Useful ions of IVA and VA elements in low oxidation states include Bi³⁺. Donor emitter ions useful in the present invention include, but are not limited to, Ce³⁺, Pr³⁺, Sm³⁺, Eu²⁺, Dy³⁺, and Yb³⁺. In a given phosphor, the donor emitter ion is selected so that it is different from the acceptor emitter ion.

A co-activator ion is selected from divalent and trivalent rare earth (lanthanide), actinide, and lutetium ions, and ions of IVA and VA elements in low oxidation states. Useful actinide ions include uranium ions. Useful ions of IVA and VA elements in low oxidation states include Bi³⁺. Co-activator ions may be selected from the group: Pr³⁺, Ho³⁺, Nd³⁺, Dy³⁺, Eu²⁺, Er³⁺, La³⁺, Lu³⁺, Ce³⁺, Y³⁺, Sm³⁺, Gd³⁺, Tb³⁺, Tm³⁺, and Yb³⁺ and Bi³⁺. Co-activator ions especially useful in the present invention include, but are not limited to Dy³⁺, Tm³⁺, and Y³⁺.

The invention also provides a method for generating long persistent phosphorescence at selected colors which is resistant to high temperatures and water. The resistance to high temperatures and water is obtained by coating the phosphor with a reducing material such as a hydrate of ZrOCl₂. It is this coating that provides protection from both heat and water.

The invention also provides a method for making a long-persistent phosphor comprising the steps of (a) combining at least one source material for a host, at least one source material for a donor ion, at least one source material for an acceptor ion, and, optionally, at least one source material for a co activator; and (b) sintering the combined source materials in a reducing atmosphere. As used herein, a source material is equivalent to a phosphor component.

Those of ordinary skill in the art will appreciate that the phosphors of this invention can be prepared using starting materials other than those specifically disclosed herein and that procedures and techniques functionally equivalent to those described herein can be employed to make and assess the phosphors herein. Those of ordinary skill in the art will also appreciate that the host matrix of this invention may accommodate metal ions other than those specifically mentioned herein without significant effect upon phosphor properties. Therefore, the preparation of a luminescent phosphor consistent with the present invention should not be construed as limited to the following examples.

Luminescent Phosphor Example 1

A method to manufacture a luminescent phosphor with the chemical formula of SrMgAl₄O₈:Eu²⁺Dy³⁺ is described below. The base materials used to manufacture SrMgAl₄O₈:Eu²⁺Dy³⁺ are SrCO₃, MgO, Al₂O₃, and H₃BO₃, (NH₄)₂HPO₄ and fluorescent level Eu₂O₃ and Dy₂O₃. The chemical reaction principles of this luminescent phosphor are:
SrCO₃+MgO+2Al₂O₃→SrMgAl₄O₈+CO₂⇑

The following steps produce a heat resistant, water tolerant, high brilliance, long life luminescent phosphor emitting a yellow-green colored light having a wavelength of approximately 520 nm.

1. Prepare 46.56 g of Al₂O₃, 33.69 g of SrCO₃, 9.22 g or MgO, 2.83 g of H₃BO₃, 3.01 g of (NH₄)₃HPO₄, 1.29 g of Eu₂O₃, and 3.40 g of Dy₂O₃.

2. Grind the components to a powder.

3. Heat the mixture for 3 hours at a temperature of 1,300° C. under a gaseous mixture of N₂ and H₂.

4. Cool the mixture to room temperature.

5. Grind the mixture into a powder and sift to obtain raw luminescent phosphor powder.

To make a luminescent phosphor that is resistant to both heat and water follow with the additional steps of:

6. While stirring a solution of ZrOCl2.8H2O at a temperature of 60° C., add the raw luminescent phosphor powder to a solution and continue agitation for 2 hours.

7. Once the mixture has achieved a homogenous consistency, add ammonia water and stir for an additional 2 hours.

8. Rinse the powder with water.

9. Once rinsing is complete, mix the powder with water in equal parts by volume of water\powder to create a liquid having a thick consistency.

10. Add tri-ethanolamine solution having a ratio of 1 part water to 1 part tri-ethanolamine solution and continue stirring.

11. Dry the mixture at a temperature of 120° C.

12. Grind the mixture into a powder and sift to obtain a heat resistant, water tolerant, high brilliance, long life luminescent phosphor producing a yellow-green colored light.

Luminescent Phosphor Example 2

A method to manufacture a luminescent phosphor with the chemical formula of Sr₂MgAl₁₀O₁₈:Eu²⁺Dy³⁺ is described below. The base materials used to manufacture Sr₂MgAl₁₀O₁₈:Eu²⁺Dy³⁺ are SrCO₃, MgO, Al₂O₃, and H₃BO₃, (NH₄)₂HPO₄ and fluorescent level Eu₂O₃ and Dy₂O₃. The chemical reaction principles of this luminescent phosphor are:
2SrCO₃+MgO+5Al₂O₃→Sr₂MgAl₁₀O₁₈+2CO₂⇑

The following step produce a heat resistant, water tolerant, high brilliance, long life luminescent phosphor emitting a blue-green colored light having wavelength of approximately 489 nm.

1. Prepare 46.56 g of Al₂O₃, 33.69 g of SrCO₃, 9.22 g of MgO, 2.83 g of H₃BO₃, 3.01 g of (NH₄)₃HPO₄, 1.29 g of Eu₂O₃, and 3.40 g of Dy₂O₃.

2. Grind the components to a powder.

3. Heat the mixture for 4 hours at a temperature of 1,300° C. under a gaseous mixture of N₂ and H₂.

4. Cool the mixture to room temperature.

5. Grind the mixture into a powder and sift to obtain raw luminescent phosphor powder.

To make a luminescent phosphor that is resistant to both heat and water follow with the additional steps of:

6. While stirring a solution of ZrOCl2.8H2O at a temperature of 60° C., add the raw luminescent phosphor powder to a solution and continue agitation for 2 hours.

7. Once the mixture has achieved a homogenous consistency, add ammonia water and stir for an additional 2 hours.

8. Rinse the powder with water.

9. Once rinsing is complete, mix the powder with water in 4 parts by volume of water to 6 parts by volume powder to create a liquid having a thick consistency.

10. Add tri-ethanolamine solution having a ratio of 1 part water to 1 part tri-ethanolamine solution and continue stirring.

11. Dry the mixture at a temperature of 120° C.

12. Grind the mixture into a powder and sift to obtain a heat resistant, water tolerant, high brilliance, long life luminescent phosphor producing a blue-green colored light.

Luminescent Phosphor Example 3

A method to manufacture a luminescent phosphor blend is described below. The following steps produce a heat resistant, water tolerant, high brilliance, long life luminescent phosphor emitting a green colored light having wavelength of approximately 500 nm.

1. Prepare 4 moles of the luminescent phosphor of Example 1.

2. Prepare 6 moles of the luminescent phosphor of Example 2.

3. Grind the phosphors of Step 1 and Step 2

4. Mix thoroughly to produce a heat resistant, water tolerant, high brilliance, long life luminescent phosphor emitting a green colored light.

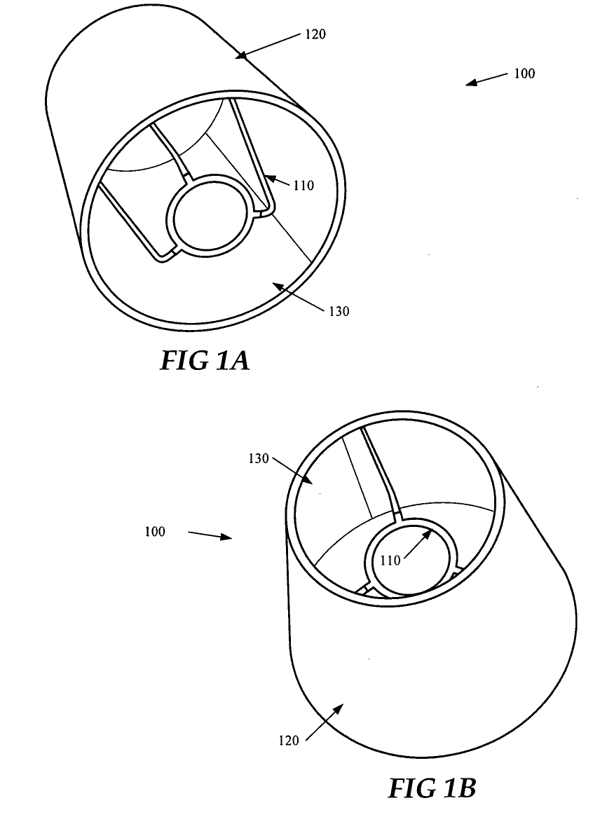

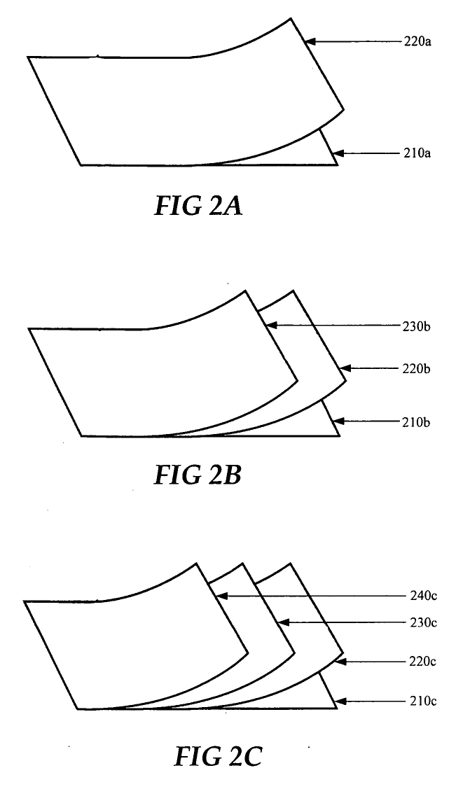

Referring more particularly to the drawing, FIG. 1A is a view of the underside of a lamp shade 100 and FIG. 1B is a view of the top of a lamp shade 100 consistent with an exemplary embodiment of the present invention. A support structure 110 is made available for attaching the lamp shade 100 to a lighting fixture. The lamp shade 100 is comprised of multiple layers, as will be seen in FIG. 2. An outer layer 120 that may be a translucent polymer, ceramic or other light conducting material comprises a combination of a polymer and a luminescent phosphor. The combination may comprise a mixture of luminescent phosphor dispersed throughout the polymer or a luminescent phosphor applied to a polymer as a surface coating. The polymer, ceramic or other light conducting material is not limited to a thermoset or thermoplastic resin. A non-exclusive list of examples of a translucent polymer or other light conducting material includes polyvinyl chloride (PVC), polyethylene, ethyl acetate, polystyrene, polypropylene, and glass.

In an exemplary embodiment the inner layer 130 or any other intermediate layer is a reflector. The reflector can be fabricated from any material such has plastics, metal, alloys, or ceramics. The reflector can be any color; however, in an exemplary embodiment the reflector is white.

In an alternate embodiment (not shown) the out layer may be a cloth, paper, ink, or other opaque and/or semitransparent material that is applied to produce decorative designs. For example, if the lamp shade is to be used in a child bedroom, the child may apply fabric or paper cuts of various shapes, or draw on the outer layer with paints or markers to produce designs that will be projected upon various surfaces at bed time when the lamp shade is acting as a night light for the child. In another example, cellophane of various colors may be applied to alter the color of emitted light.

FIGS. 2A-2C depict a method of constructing a lamp shade consistent with various embodiments of the present invention. FIG. 2A depicts an embodiment of the present invention in its most basic form. A first layer 210a could be a translucent polymer, ceramic or other light conducting material comprising a luminescent phosphor. Upon illumination by incident electromagnetic radiation, the first layer 210a containing a luminescent phosphor stores energy. When the illumination by incident electromagnetic radiation ceases, the first layer 210a will glow in the dark. Depending on the luminescent phosphor used, the exposure time to incident radiation, and wavelength of incident radiation; the glow time ranges from a couple of minutes to over 8 hours. In an exemplary embodiment, the luminescent phosphor is evenly distributed throughout the first layer 210a. In an alternate embodiment, the luminescent phosphor may be applied as a surface coating to the first layer 210a.

The embodiment depicted in FIG. 2A further includes a second layer 220a comprising a reflector. The reflector 220a reflects light emitted by the first layer 210a into a space. For example, in the lamp shade configuration as depicted in FIG. 1A, light emitted by the first layer 210a toward the center of the lamp shade is not being used to illuminate a space effectively. Therefore, the second layer 220a reflects light that would otherwise be emitted toward the center of the lamp shade out into the space needing illumination.

FIG. 2B depicts an alternate embodiment of the present invention. In this embodiment, a first layer 210b is an outer layer as described above regarding the alternate embodiment of FIG. 1A and FIG. 1B. The first layer 210b may be a cloth, paper, ink, or other opaque and/or semitransparent material. This first layer 210b may be applied during the manufacturing process or left for the end user to apply. For example, first layer 210b can be fabric or paper cuts of various shapes applied by a child. In another example, the out layer may be clear cellophane that allows a child to draw on the lamp shade with markers. Should the child want to change the design on the lamp shade, the cellophane can be removed and a new cellophane layer applied.

A second layer 220b comprises a translucent polymer, ceramic or other light conducting material combined with a luminescent phosphor. Upon illumination by incident electromagnetic radiation, the second layer 220b containing a luminescent phosphor stores energy. When the illumination by incident electromagnetic radiation ceases, the second layer 220b will glow in the dark. Depending on the luminescent phosphor used, the exposure time to incident radiation, and wavelength of incident radiation; the glow time ranges from a couple of minutes to over 8 hours. In an exemplary embodiment, the luminescent phosphor is evenly distributed throughout the second layer 220b. In an alternate embodiment, the luminescent phosphor may be applied as a surface coating to the second layer 220b.

A third layer 230b comprises a reflector. The reflector reflects light emitted by the second layer 220b out into a space. For example, in the lamp shade configuration as depicted in FIG. 1A, light emitted by the second layer 220b toward the center of the lamp shade is not being used to illuminate a space effectively. Therefore, the third layer 230b reflects light that would otherwise be emitted toward the center of the lamp shade out into the space needing illumination.

Alternatively, FIG. 2B depicts a second alternate embodiment of the present invention. A first layer 210b could be a translucent polymer, ceramic or other light conducting material comprising a luminescent phosphor. Upon illumination by incident electromagnetic radiation, the first layer 210b containing a luminescent phosphor stores energy. When the illumination by incident electromagnetic radiation ceases, the first layer 210b will glow in the dark. Depending on the luminescent phosphor used, the exposure time to incident radiation, and wavelength of incident radiation; the glow time ranges from a couple of minutes to over 8 hours. In an exemplary embodiment, the luminescent phosphor is evenly distributed throughout the first layer 210b. In an alternate embodiment, the luminescent phosphor may be applied as a surface coating to the first layer 210b.

A second layer 220b comprises a reflector. The reflector 220b reflects light emitted by the first layer 210b out into a space. For example, in the lamp shade configuration as depicted in FIG. 1A, light emitted by the first layer 210b toward the center of the lamp shade is not being used to illuminate a space effectively. Therefore, the second layer 220b reflects light that would otherwise be emitted toward the center of the lamp shade out into the space needing illumination.

A third layer 230b, or inner layer as shown in FIG. 1A and FIG. 1B by reference numeral 130, is a backing layer. Non-exclusive examples of usages for this backing layer are to provide strength to the lamp shade structure and/or as a mounting surface for hardware used to mount the lamp shade to a light fixture. The third layer 230b can be constructed of rigid materials such as metals, alloys, or plastics. Furthermore, the third layer 230b can be transparent, semitransparent, or opaque.

The lamp shade of FIG. 2C is another embodiment that comprises four layers. FIG. 2C is best described by way of an example. A first layer 210c is an outer layer as described above regarding the alternate embodiment of FIG. 1A and FIG. 1B. The first layer 210c may be a cloth, paper, ink, or other opaque and/or semitransparent material. This first layer 210c may be applied during the manufacturing process or left for the end user to apply. For example, first layer 210c can be fabric or paper cuts of various shapes applied by a child. In another example, the out layer may be clear cellophane that allows a child to draw on the lamp shade with markers. Should the child want to change the design on the lamp shade, the cellophane can be removed and a new cellophane layer applied.

A second layer 220c is a translucent polymer, ceramic or other light conducting material comprising a luminescent phosphor. Upon illumination by incident electromagnetic radiation, the second layer 220c containing a luminescent phosphor stores energy. When the illumination by incident electromagnetic radiation ceases, the second layer 220c will glow in the dark. Depending on the luminescent phosphor used, the exposure time to incident radiation, and wavelength of incident radiation; the glow time ranges from a couple of minutes to over 8 hours. In an exemplary embodiment, the luminescent phosphor is evenly distributed throughout the second layer 220c. In an alternate embodiment, the luminescent phosphor may be applied to the surface of the second layer 220c.

A third layer 230c comprises a reflector. The reflector 230c reflects light emitted by the second layer 220c out into a space. For example, in the lamp shade configuration as depicted in FIG. 1A, light emitted by the second layer 220c toward the center of the lamp shade is not being used to illuminate a space effectively. Therefore, the third layer 230c reflects light that would otherwise be emitted toward the center of the lamp shade out into the space needing illumination.

A fourth layer 240c, or inner layer as shown in FIG. 1A and FIG. 1B by reference numeral 130, is a backing layer. Non-exclusive examples of usages for this backing layer are to provide strength to the lamp shade structure and/or as a mounting surface for hardware used to mount the lamp shade to a light fixture. The fourth layer 240c can be constructed of rigid materials such as metals, alloys, or plastics. Furthermore, the fourth layer 240c can be transparent, semitransparent, or opaque.

Consistent with FIG. 2C, construction of a lamp shade such as depicted in FIG. 1A and FIG. 1B would comprise a multi-step process. An example of the steps for constructing the lamp shade of FIG. 1A and FIG. 1B would comprise: 1) forming the fourth layer 240c into a circular shape, 2) wrapping the fourth layer 240c by forming a third layer 230c which is a reflector around the fourth layer 240c, 3) wrapping the third layer 230c with a second layer 220c wherein the second layer 220c is a light conducting material which comprises a luminescent phosphor, and 4) applying a first layer 210c wherein the first layer 210c is a decorative layer.

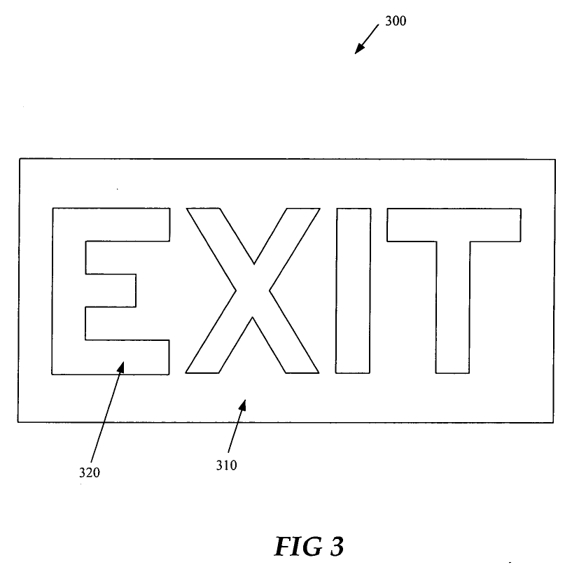

FIG. 3 depicts an alternate embodiment of the present invention in the form of a lamp shade which has been fashioned into an exit sign 300. The exit sign 300 comprises a cover plate 310 and lettering 320. In an exemplary embodiment, the cover plate 310 and lettering 320 cover a light bulb. The cover plate 310 may act as a reflector and lettering 320 is transparent to allow light from the light bulb to be emitted during normal usage. In the event of an emergency or outage of power, lettering 320 will glow and alert occupants as to where the exits are located.

The signage depicted in FIG. 3 has many advantages over current emergency signage. The biggest advantage is the elimination of batteries, which require checking and changing, currently required for emergency lighting.

Reference has been made throughout this specification to “one embodiment,” “an embodiment,” “an exemplary embodiment,” “an alternative embodiment,” or “an example embodiment” meaning that a particular described feature, structure, or characteristic is included in at least one embodiment of the present invention. Thus, usage of such phrases may refer to more than just one embodiment. Furthermore, the described features, structures, or characteristics may be combined in any suitable manner in one or more embodiments.

One skilled in the relevant art may recognize, however, that the invention may be practiced without one or more of the specific details, or with other methods, resources, materials, etc. In other instances, well known structures, resources, or operations have not been shown or described in detail merely to avoid obscuring aspects of the invention.

While example embodiments and applications of the present invention have been illustrated and described, it is to be understood that the invention is not limited to the precise configuration and resources described above. Various modifications, changes, and variations apparent to those skilled in the art may be made in the arrangement, operation, and details of the methods and systems of the present invention disclosed herein without departing from the scope of the claimed invention.

I claim:

1. A multilayer lamp shade comprising:
a. a first layer; and
b. a second layer;
wherein said first layer is a reflector and said second layer is a light conducting material comprising a luminescent phosphor, wherein said light conducting material is exposed to a source of electromagnetic radiation, and wherein said reflector reflects electromagnetic radiation emitted by said luminescent phosphor.

2. The lamp shade of claim 1 further comprising a third layer.

3. The lamp shade of claim 2, wherein said third layer is a decorative layer for allowing for ornamental design application.

4. The lamp shade of claim 2, wherein said third layer comprises a rigid material, wherein said rigid material provides structural support.

5. The lamp shade of claim 1, wherein said second layer comprises at least 52% by volume said light conducting material and at most 48% by volume said luminescent phosphor.

6. The lamp shade of claim 1, wherein said second layer comprises 80% by volume said light conducting material and 20% by volume said luminescent phosphor.

7. The lamp shade of claim 1, wherein said light conducting material is a polymer.

8. The lamp shade of claim 1, wherein said lamp shade forms signage.

9. An article of manufacture comprising: SrMgAl₄O₈:Eu²⁺Dy³⁺.

10. An article of manufacture comprising: Sr₂MgAl₁₀O₁₈:Eu²⁺Dy³⁺.

11. A luminescent phosphor compound of formula:
Sr_{w}MgₓAl_{y}O_{z}:dD,cC
wherein D is a donor ion, C is a co activator ion, w≧1, x≧1, y≧1, z≧1, 0.001%≦d≦0.5%, and 0.01%≦c≦2.0%.

12. The compound of claim 11, wherein D is Eu²⁺.

13. The compound of claim 11, wherein d=0.1%.

14. The compound of claim 11, wherein C is Dy³⁺.

15. The compound of claim 11, wherein c=1.0%.

16. The compound of claim 11 further comprising a cover material, wherein said cover material coats said compound.

17. The compound of claim 16, wherein said cover material comprises a hydrate of ZrOCl₂.

18. The compound of claim 17 wherein said cover material comprises ZrOCl₂.8H₂O.

19. The compound of claim 16, wherein said cover material comprises tri-ethanolamine.

20. A method for producing a luminescent phosphor comprising:
a. combining SrCO₃, MgO, Al₂O₃, Eu₂O₃ and Dy₂O₃ to produce a powder; and
b. sintering said powder at a temperature of about 1,200° C.-1,600° C. for about 2-5 hours under a reduction environment.

21. The method of claim 20, further comprising:
a. combining a hydrate of ZrOCl₂ to produce a mixture;
b. heating the mixture;
c. adding a reducing agent to the heated mixture;
d. adding tri-ethanolamine; and
e. drying the mixture.

22. A method of treating a luminescent phosphor to make the luminescent phosphor resistant to heat and water comprising:
a. combining the luminescent phosphor with a hydrate of ZrOCl₂ to produce a mixture;
b. heating the mixture;
c. adding a reducing agent to the heated mixture;
d. adding tri-ethanolamine; and
e. drying the mixture.
